(19) United States
(12) Patent Application Publication
(10) Pub. No.: US 2026/0086977 A1
(43) Pub. Date: Mar. 26, 2026

(54) MULTIPLE INSTANTIATION-AWARE VIRTUAL CHANNEL ASSIGNMENT AND COMPRESSION IN NETWORK-ON-CHIP

(71) Applicant: Baya Systems, Inc., Santa Clara, CA (US)

(72) Inventors: Honnahuggi Harinath Venkata Naga Ambica Prasad, Bengaluru (IN); Eric Norige, Santa Clara, CA (US)

(21) Appl. No.: 18/949,670

(22) Filed: Nov. 15, 2024

(30) Foreign Application Priority Data
Sep. 24, 2024 (IN) 202411072167

(51) Int. Cl. G06F 15/78; H04L 49/109

(52) U.S. Cl. CPC G06F 15/7825; H04L 49/109

(57) ABSTRACT

A method for generating a Network on Chip (NoC) that includes computing a virtual channel (VC) mapping that associates each flow of the NoC with a split VC identifier, the split VC identifier including a host VC identifier and a discriminant and generating the NoC comprising multiply instantiated routers, wherein a design of each of the multiply instantiated routers is configured with allocated VC identifiers according to the VC mapping. Further, the method includes remapping the VC identifiers for each of the multiply instantiated routers based on its connection to other ones of the multiply instantiated routers and where allocation of VC identifiers is conducted according to each slice of the design of the multiply instantiated routers. Using split VC identifiers allows the multiply instantiated routers to have VC remapping/transformation functions that enable desired VC remapping at a plurality of positions on the NoC.

### CROSS-REFERENCE TO RELATED APPLICATIONS

This application claims priority to IN 202411072167, filed on September 24, 2024, the contents of which are incorporated herein by reference.

### BACKGROUND

### Technical Field

Methods and example embodiments described herein are generally directed to generating a Network on Chip (NoC), and more specifically, to assignment and compression of Virtual Channels (VCs) in NoC architectures that are aware of multiple instantiations.

### Related Art

The number of components on a chip is rapidly growing due to increasing levels of integration, system complexity, and shrinking transistor geometry. Complex System-on-Chips (SoCs) may involve a variety of components e.g., processor cores, Digital Signal Processors (DSPs), hardware accelerators, memory, and Input/Output (I/O) interfaces, while Chip Multi-Processors (CMPs) may involve a large number of homogenous processor cores, memory, and I/O subsystems. In both systems, on-chip interconnect plays a key role in providing high-performance communication between the various components. Due to scalability limitations of traditional buses and crossbar-based interconnects, Network-on-Chip (NoC) has emerged as a paradigm to interconnect a large number of components on the chip.

The NoC is a global shared communication infrastructure made up of several routing nodes interconnected with each other using point-to-point physical links. Messages are injected by source components and are routed from the source components to a destination component over multiple intermediate nodes and physical links. The destination component then ejects the message and provides it to other components associated with the destination component. For the remainder of the document, the terms ‘processing elements,’ ‘components,’ ‘blocks,’ ‘hosts,’ or ‘cores,’ will be used interchangeably to refer to the various system components that are interconnected using a NoC. The terms ‘routers’ and ‘nodes’ will also be used interchangeably. Without loss of generalization, the system with multiple interconnected components will itself be referred to as a ‘multi-core system’.

There are several possible topologies in which the routers can connect to one another to create the system network. Bi-directional rings 100A (as shown in FIG. 1(a)) and 2-D mesh 100B (as shown in FIG. 1(b)) are examples of topologies in the related art.

Packets are message transport units for intercommunication between various components. Routing involves identifying a path, which is a set of routers and physical links of the network over which packets are sent from a source to a destination. Components are connected to one or multiple ports of one or multiple routers, with each such port having a unique identifier (ID). Packets carry the destination’s router and port ID for use by the intermediate routers to route the packet to the destination component.

Examples of routing techniques include deterministic routing, which involves choosing the same path from A to B for every packet. This form of routing is oblivious to the state of the network and does not load balance across path diversities that may exist in the underlying network. However, such deterministic routing may be simple to implement in hardware, maintain packet ordering, and may be easy to make free of network-level deadlocks. Shortest path routing minimizes the latency as it reduces the number of hops from the source to the destination. For this reason, the shortest path is also the lowest power path for communication between the two components. Dimension-order routing is a form of deterministic shortest-path routing in 2D mesh networks.

FIG. 2 illustrates an example of XY routing in a two-dimensional mesh 200. More specifically, FIG. 2 illustrates XY routing from node ‘34’ to node ‘00’. In the example of FIG. 2, each component is connected to only one port of one router. A packet is first routed in the X dimension till the packet reaches node ‘04’ where the ‘X’ dimension is the same as the destination. The packet is next routed in the ‘Y’ dimension until the packet reaches the destination node.

Source routing and routing using tables are other routing options used in NoC. Adaptive routing can dynamically change the path taken between two points on the network based on the state of the network. This form of routing may be complex to analyze and implement and is therefore rarely used in practice.

The NoC may contain multiple physical networks. Over each physical network, there may exist multiple virtual networks, where different message types are transmitted over different virtual networks. In this case, at each physical link or channel, there are multiple virtual channels (VCs), and each VC may have dedicated buffers at both endpoints. In any given clock cycle, only one VC can transmit data on the physical channel.

NoC interconnects often employ wormhole routing, where a large message or packet is broken into small pieces known as flits (also referred to as flow control digits). The first flit is the header flit which holds information about the packet’s route and key message level information along with payload data and sets up the routing behavior for all subsequent flits associated with the message. Zero or more body flits follow the head flit, containing the remaining payload of data. The final flit is a tail flit, which, in addition to containing the last payload, performs some bookkeeping to close the connection for the message. In wormhole flow control, VCs are often implemented.

The physical channels are time-sliced into a number of independent logical channels, i.e. VCs. VCs provide multiple independent paths to route packets, however, they are time-multiplexed on the physical channels. A VC holds the state needed to coordinate the handling of the flits of a packet over a channel. At a minimum, this state identifies the output channel of the current node for the next hop of the route and the state of the virtual channel (idle, waiting for resources, or active). The VC may also include pointers to the flits of the packet that are buffered on the current node and the number of flit buffers available on the next node.

The term “wormhole” refers to the way messages are transmitted over the channels: the output port at the next router can be so short that received data can be translated in the head flit before the full message arrives. This allows the router to quickly set up the route upon arrival of the head flit and then opt-out from the rest of the conversation. Since a message is transmitted flit by flit, the message may occupy several flit buffers along its path at different routers, creating a worm-like image.

Based on the traffic between various endpoints, and the routes and physical networks that are used for various messages, different physical channels of the NoC interconnect may experience different levels of load and congestion. The capacity of various physical channels of a NoC interconnect is determined by the width of the channel (number of physical wires) and the clock frequency at which it is operating. Various channels of the NoC may operate at different clock frequencies. However, all channels are equal in width or number of physical wires. This width can be determined based on the most loaded channel and the clock frequency of various channels.

### SUMMARY

Aspects of the present disclosure are directed to a method for generating a Network on Chip (NoC). The method includes computing a virtual channel mapping that associates each flow of the NoC with a split virtual channel identifier, the split virtual channel identifier including a host virtual channel identifier and a discriminant. The method further includes generating the NoC including multiply instantiated routers, where a design of each of the multiply instantiated routers is configured with allocated virtual channel identifiers according to the virtual channel mapping.

Additional aspects of the present disclosure are directed to a non-transitory computer-readable medium storing instructions for generating a NoC, the instructions include computing a virtual channel mapping that associates each flow of the NoC with a split virtual channel identifier, the split virtual channel identifier including a host virtual channel identifier and a discriminant, and generating the NoC including multiply instantiated routers, where a design of each of the multiply instantiated routers is configured with allocated virtual channel identifiers according to the virtual channel mapping.

Additional aspects of the present disclosure are directed to a system with a control module configured to compute a virtual channel mapping that associates each flow of the NoC with a split virtual channel identifier, the split virtual channel identifier including a host virtual channel identifier and a discriminant. The control module is also configured to generate the NoC including multiply instantiated routers, where a design of each of the multiply instantiated routers is configured with allocated virtual channel identifiers according to the virtual channel mapping.

### BRIEF DESCRIPTION OF THE DRAWINGS

FIGS. 1(A) and 1(B) illustrate examples of bidirectional ring and 2D Mesh Network on Chip (NoC) topologies.

FIG. 2 illustrates an example of XY routing in a NoC having a two-dimensional mesh topology.

FIG. 3 illustrates a schematic representation of a NoC having routers that perform Virtual Channels (VCs) remapping/transformations.

FIG. 4 illustrates a flowchart of a method for generating a NoC having routers with router designs that are multiply instantiable and allow for VC remapping, in accordance with an example implementation.

FIGS. 5A to 5C illustrate example representations of router designs being generated using the method shown in FIG. 4, in accordance with an example implementation.

FIG. 6 illustrates a computer/server block diagram upon which the example implementations described herein may be implemented.

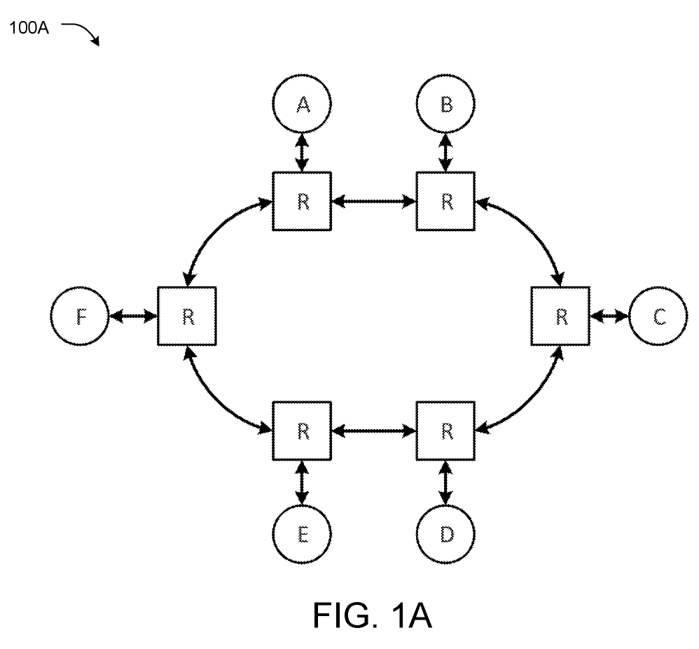

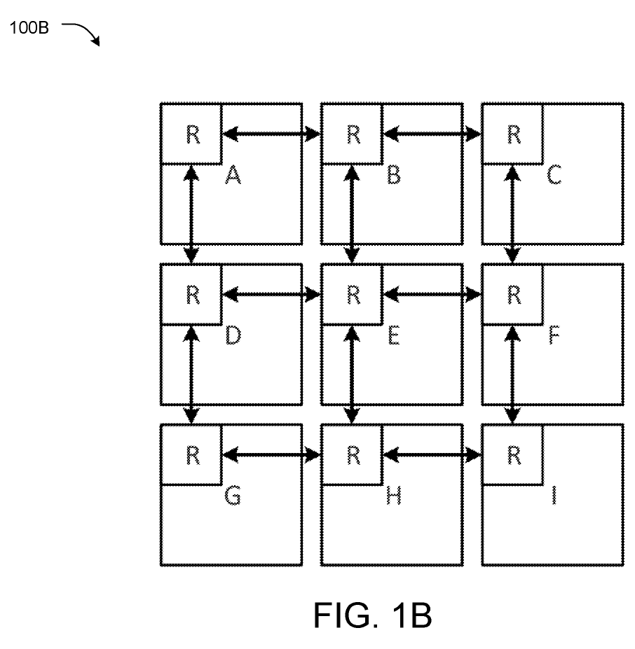

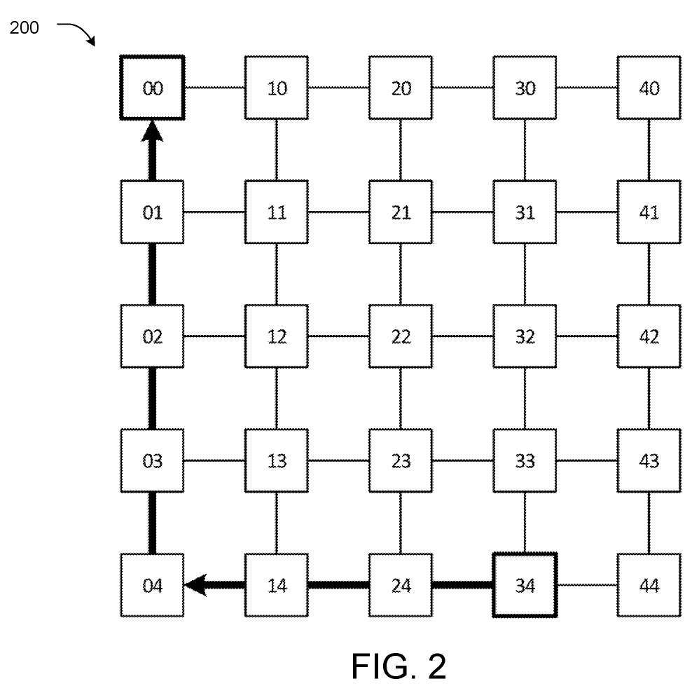

### DETAILED DESCRIPTION

In existing Network on Chip (NoC) architectures, a significant issue lies in effectively managing and transforming Virtual Channels (VCs) at NoC components. The VC transformation refers to the remapping of the data packets from a first VC associated with the NoC (or NoC components) to a second VC associated with a host (or another NoC component), and vice-versa. However, implementing VC transformation functions in NoC components, such as routers or bridges, introduces many challenges. For example, in the NoC, if the multiple routers are tasked with directing traffic to different destination hosts on different VCs, each router needs unique VC transformation logic to remap VCs during routing and/or ejection of packets. However, coordinating these VC transformations across multiple routers is highly complex. For instance, particular VCs of input ports of NoC components may be directed to different VCs associated with different destinations/other NoC components in different instances of the same design/NoC components (such as for adapting different instantiations of the same router for different use cases/transformations). Further, existing implementations do not use separate routing bits to indicate the transformation/change in VCs required when moving packets from one NoC component to the destination/another NoC component. The need for the use of multi-instancing and the lack of routing bits increases the complexity of configuring VC identifiers to be compatible across all instances of the NoC components, which creates non-local constraints on assignment of VC identifiers.

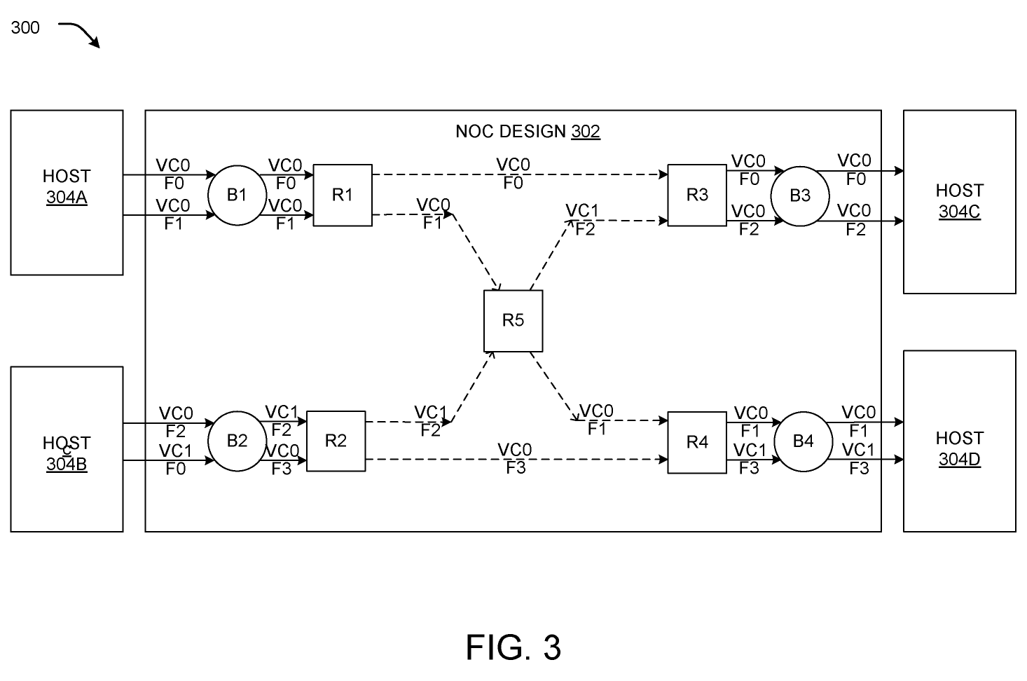

FIG. 3 illustrates a schematic representation 300 of a NoC design 302 having routers that perform VC remapping.

Referring to FIG. 3, the NoC 302 may include bridges (B1, B2, B3, and B4) that are connected to corresponding routers (R1, R2, R3, and R4). The NoC 302 may allow packets to flow between hosts, such as from transmitting hosts 304A and 304B to receiving hosts 304D and 304C, respectively (collectively referred to as hosts 304). Paths taken by the data packets are depicted using flows. Flows are depicted as F0 to F3. F0 represents a flow between the host 304A and 304C using NoC VC0 and host VC0 through a transport network. The transport network includes multiple NoC components (such as the routers R1 to R5), that allow packets to be transmitted from one host 304 to another. The dotted lines passing through router R5 indicate that more NoC components/routers may be implemented/used between the routers R1- R4 and router R5, which are not shown for the purposes of clarity. Flow F1 represents a path for transporting packets from host 304A to host 304D through the transport network. As indicated, the flow F1 may use host VC0 between the transmitting host 304A and router R1, through the router R5, and between router R4 and receiving host 304D. Similarly, another flow F2 represents a path for transporting packets from host 304B to host 304C. In flow F2, the packets may be transported through host VC0 between the host 304B and router R2, and between router R3 and receiving host 304C, but use NoC VC1 through the router R5/transport network. Further, flow F3 may use host VC1 at the hosts 304B and 304D, and use NoC VC0 through the transport network (i.e. between the routers R2 and R4). Such flows require VC transformations/remapping at the routers to allow the packets to be transported using different VCs in the transport network (such as router R5), and between the routers and the hosts. Throughout the specification, the VC between the hosts 304 and the NoC 302 are referred to as “host VCs” and the VCs associated with the transport network (such as routers R1 to R5) are referred to as “NoC VCs.” While FIG. 3 shows the use of five routers, the NoC 302 may be suitably adapted to have any number of NoC components in the transport network.

Typically, VC remapping/transformation functions are performed at routers, instead of bridges, to avoid requiring additional mechanisms for addressing crediting issues. For example, the credits sent by the host 304C on receipt of packets at the host VC0 (since the host 304D receives the flits/packets on VC0) to router R3 may have to be adjusted with respect to the NoC VC1 (since the router R3 receives the packets from NoC VC1), and not with respect to other VCs. This creates a need for additional mechanisms/logic to ensure the credits are utilized for the appropriate NoC VCs, which raises costs. The credit problem becomes particularly obvious when multiple NoC VCs are sharing the same host VC, as it inhibits the ability of the NoC to be scaled, which can be avoided by implementing the transformation function within the routers. The transformation functions may be implemented within the routers by 1-hot encoding VC identifiers (ID) between input and output of router (or any NoC component) and implementing a X->Y VC ID transform by connecting the pin for VC ID X at the router input logic to the pin for VC ID Y at the router output logic. Logical gates may also be included between the input ports and the output ports for providing additional control over remapping of the VCs for a given flow.

However, growing interest in the need for multi-instancing of NoC components (such as to complement multi-instancing in System-on-Chip (SoC) or Chip Multi-processors (CMP)) creates a need for multiply instantiable router designs having VC transformation/remapping functions that may be configured to support different VC transformations required for different hosts. Multi-instancing of the routers may require a design with transformation functions that are configured to support different kinds of VC remapping based on the location of the routers in the NoC. For instance, in the example NoC 302 shown in FIG. 3, designs of the routers R3 and R4 require different transformations functions, i.e. for remapping NoC VC0 to host VC0 and NoC VC1 to host VC0. If the router designs have incompatible transformation functions, a single router design cannot be created that can be multiply instantiated to serve both purposes, thereby precluding any advantages that multi-instancing may otherwise provide (such as efficiency and reduction of complexity during backend design and verification, and so on). Some existing solutions use a unique set of NoC VCs for each corresponding host VCs to enable some degree of multi-instancing. However, in such solutions, the number of NoC VCs increases at least with polynomial complexity.

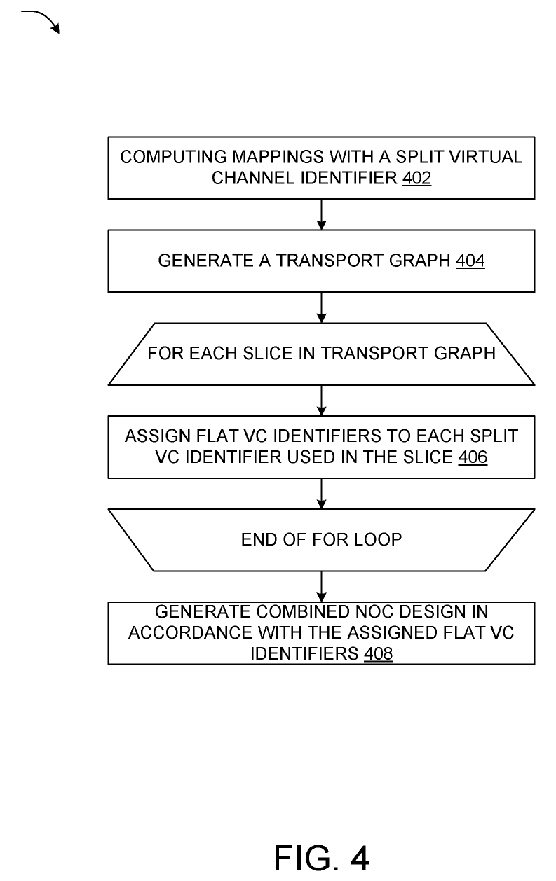

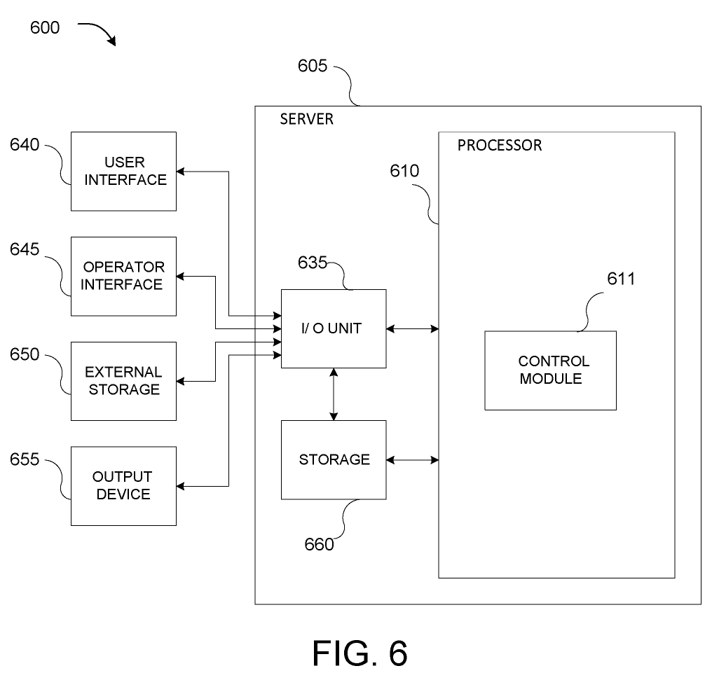

To address these challenges associated with managing and transforming VCs within the NoC, the present disclosure provides a method for generating a NoC having multiply instantiated routers. The multiply instantiated NoCs have a design configured with VC identifiers according to a VC mapping. The VC mapping may associate each flow with a split VC identifiers having a host VC identifier and a discriminant. Various embodiments of the present disclosure will be explained in detail with respect to FIGS. 4 and 6.

For designing and implementing the NoCs, the various processes such as defining a topology, configuring routers, allocating resources, and establishing communication protocols, are performed. Such processes also include generation of mappings, i.e. paths to be taken through the NoC 302 based on expected traffic flows between two or more hosts 304 defined in traffic specifications. The paths may define which input ports of which routers to use in a particular sequence for transporting packets for corresponding flows between the hosts 304. The paths may also define the VCs through which the packets are to be transported between the routers of the NoC 302. For routers in the path where the VC through which the packets are received from the input port are different from the VC through which the packets are transmitted out of the output port, the VC remapping/transformation functions may also be designed/determined and configured in the routers. As stated, for applications requiring multiple instantiations of the same router designs, the VC transformation functions may be defined in a manner that allows different instantiations of the router to map NoC VCs to host VCs (and/or vice-versa) differently based on location/position of the router in the NoC. Such design requirements may be satisfied using method 400 described in reference to FIG. 4.

FIG. 4 illustrates a flowchart of a method 400 for generating the NoC, in accordance with an example implementation.

For generating the NoC, at step 402, the method 400 includes computing a VC mapping that associates each flow of a NoC (such as the NoC 302) with split VC identifiers. In some embodiments, one split VC identifier may be assigned to each NoC component/router along the path associated with the flows. In some embodiments, the split VC identifier may include a host VC identifier and a discriminant. The host VC identifier may correspond to the VC through which the packets are to be transmitted to the receiving hosts (such as hosts 304C and 304D). The discriminant may correspond to the NoC VC using which the packets may be transmitted through the transport network. In some embodiments, the discriminant may be the NoC VC used for receiving the packet at a current NoC component from a preceding NoC component. The discriminant may allow the hosts 304 to differentiate between different NoC VCs through which the packet may be transported to the same host VC. The discriminant may be any numeric/alphabetical/symbolic value which may be used to uniquely identify each NoC VC.

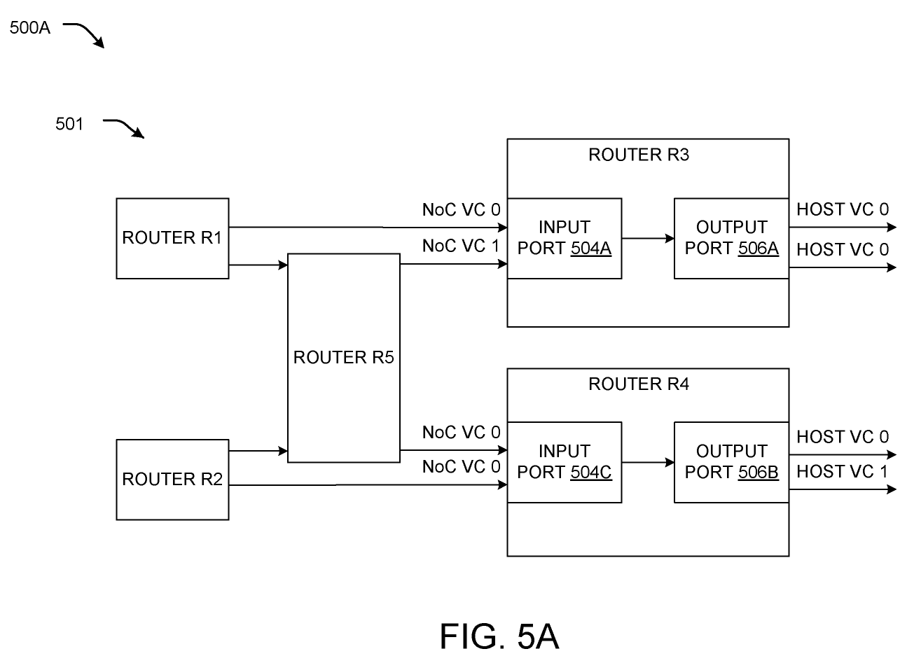

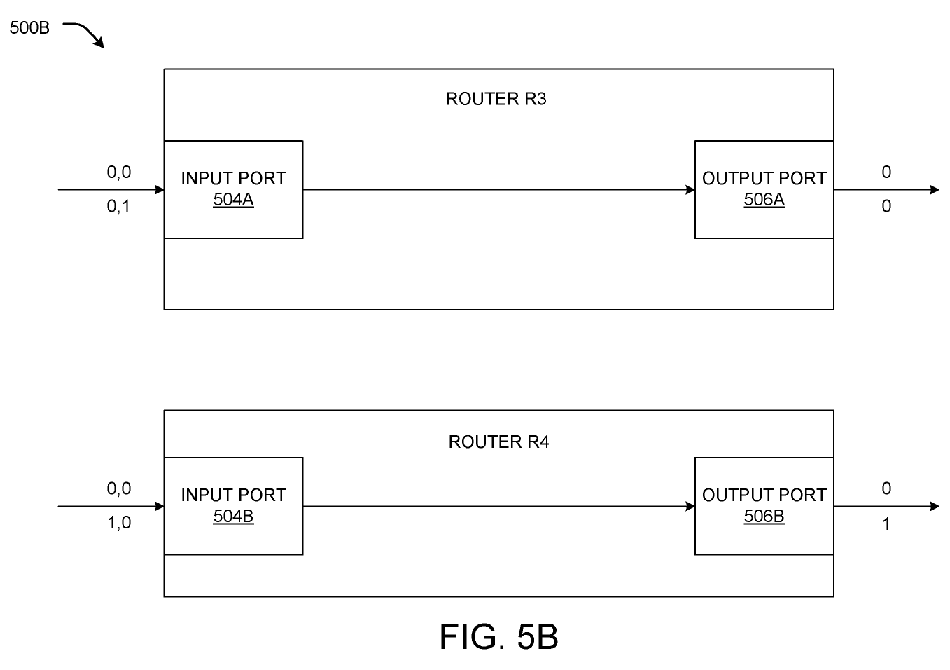

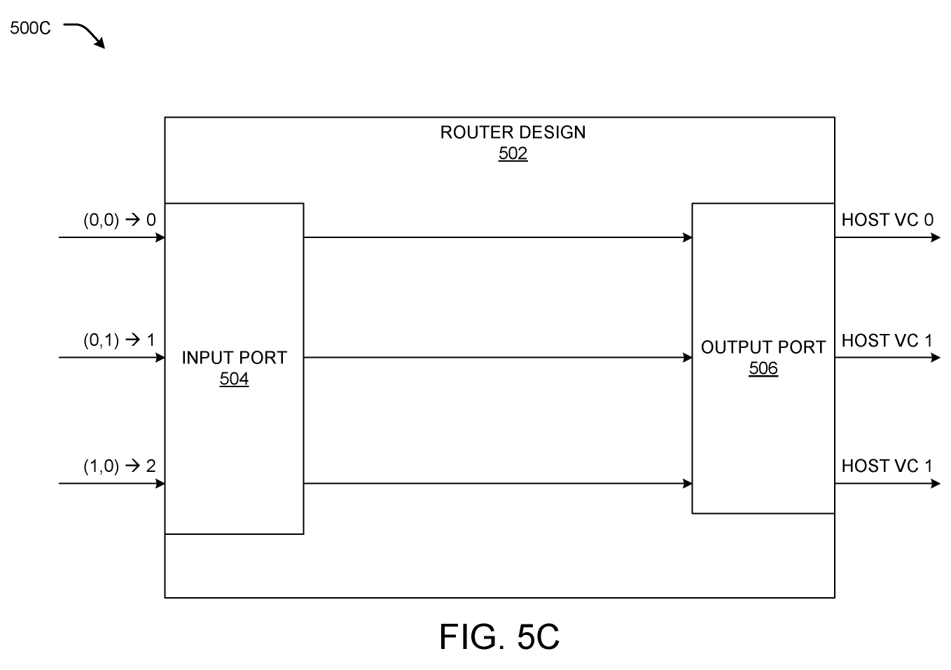

At step 404, the method 400 includes computing/generating slices from a transport graph of the NoC 302. The transport graph may include vertices/nodes corresponding to channels, and links/edges extending from the vertices corresponding to input ports and/or output ports of the NoC component to which the channels are connected. However, the transport graph may not be limited to the aforementioned representation, and any other representation known to those skilled in the art can be used for identifying slices of the NoC 302. In some embodiments, the transport graph may include one or more disjoint sub-graphs, i.e. sub-graphs that are not connected to other sub-graphs via an edge/link. Each of the sub-graphs may correspond to a slice (such as slice 501 shown in FIG. 5A) of the NoC 302.

At step 406, the method 400 includes assigning a flat VC identifier to each split VC identifier used in each of the slices. In some embodiments, the flat VC identifiers may be generated by linearizing the slices 501. In such embodiments, each unique split VC identifier may be assigned a discrete value during linearization. Each of the slices may be linearized independently of the other.

Further, at step 408, the method 400 includes generating the NoC design 302 having multiply instantiated routers/NoC components, where a design of each of the multiply instantiated routers/NoC components may be configured with allocated VC identifiers according to the VC mapping. The split VC identifiers may be used to identify the different VC transformations required at different instantiations of the NoC components in the NoC design 302, which may be used to design the NoC components such that each instantiation of the NoC component is capable of supporting the identified VC transformation. The steps of the method 400 are further elaborated through examples shown in FIGS. 5A to 5C.

As shown in representation 500A of FIG. 5A, the NoC 302 may be divided into one or more slices, such as slice 501. The slice 501 may include the set of input ports (such as input ports 504A and 504B, collectively referred to as input ports 504) and output ports (such as output ports 506A and 506B, collectively referred to as output ports 506) which transmit packets/flits to other input ports 504 and output ports 506 within the slice 501, but not to those outside the slice 501. While the slice 501 in FIG. 5A also includes input ports and output ports associated with routers R1, R2, and R5, the same are not shown for the purposes of clarity in FIG. 5A. The first input port 504A may be connected to first output port 506A at the router R3, and the second input port 504B may be connected to the second output port 506B at the router R4. The first input ports 504A may be configured to receive packets from NoC VC 0 and NoC VC 1, and the second input port 504B may be configured to receive packets from NoC VC 0. The first output port 506A may be configured to eject packets from the router R3 through host VC 0, and the second output port 506B may be configured to eject the packets from the router R4 through either through host VC 0 or host VC 1, based on the NoC VC through which the packet was received. The flows between the hosts 304 may be associated with VC identifiers to allow the packets between the hosts 304 to be transported through different host VCs and NoC VCs of the NoC 302.

In some embodiments, a set of input ports 504 and a set of output ports 506 grouped together based on port connectivity into closed groups, i.e. packets are only directed from the input ports 504 and to output ports 506 associated with the closure, and not from and to ports outside the closure. Each slice 501 may include a set of input ports 504 and output ports 506 which only transmit packets within the set, and not to other input ports 504 or output ports 506 outside the set. Each split VC identifier associated with the slices 501 may be allocated a corresponding flat VC identifier to generate the router design (such as router design 502 of FIG. 5C). In an embodiment, the (flat) VC identifiers may be allocated according to each slice 501 of the design, and that may provide a more granular and tailored approach to routing and managing the data traffic within the NoC. Further, the router design 502 may be generated based on the VC identifiers such that the NoC components (such as routers R3 and R4) are instantiable multiple times, while having VC transformation functions that support the VC transformation required at the location of the instantiation.

The VC mapping computed at step 402 may associate each flow of packets in the NoC with the split VC identifier, as shown in FIG. 5B. Referring to representation 500B of FIG. 5B, the mappings (of flows with split VC identifiers) associated with routers R3 and R4 are shown. Flows F0, and F2 that use the router R3 may be associated with split VC identifiers represented by (0, 0) and (0, 1), respectively, and flows F1 and F3 that use the router R4 may be associated with split VC identifiers represented by tuples (0, 0) and (1, 0), respectively. The first element in the tuple corresponds to host VC identifier and the second element in the tuple corresponds to the discriminant (or identifier associated with a NoC VC). For example, the split VC identifier (0, 1) indicates that the packet was received by the transport network of the NoC 302 through host VC 0, and the NoC component associated with the split VC identifier (0, 1) is configured to receive the packet through NoC VC 1. While the example represents the host VC identifier and the discriminant with numerical values in a tuple, it may be understood by those skilled in the art that the values of the split VC identifier may be any alphabetical or symbolic value, and may be represented using any other data structure. As shown in FIG. 5B, the split VC identifier (0, 0) and (0, 1) may be mapped to NoC/host VC 0, indicating that the packets received by the first input port 504A from the VCs identified by (0, 0) or (0, 1) may be ejected from the router R3 from the first output port 506A through either NoC VC 0 or the host VC 0. The split VC identifier (1, 0) may be mapped to NoC/host VC 1, indicating that the packets received by the second input port 504B from the VCs identified by (1, 0) may be ejected from the router R4 from the second output port 506B through the host VC 1.

In some embodiments, each of the split VC identifiers in each slice 501 may be converted/assigned the flat VC identifiers, which may be represented using a set of discrete values (such as in accordance with steps 404 and 406). Each discrete value may correspond to a unique split VC identifier. The use of discrete values may compress/reduce the number of bits required to represent the split VC identifiers. In some embodiments, the discriminant may provide additional information of the split VC identifier used for differentiating between different communication flows (e.g., the flow of the data) sharing the same host VC. For example, if two communication flows share the same host VC, the discriminant may be used to prioritize one flow over the other. Further, if host 304A needs to communicate with host 304D, then this communication flow may be assigned with the split VC identifier such as host VC: 0, discriminant: 0, similarly, if host 304C needs to communicate with host 304D, this communication flow may be assigned with the split VC identifier such as host VC: 0, discriminant: 1, where VC associated with discriminant 0 has priority over VC associated with discriminant 1.

As shown in representation 500C of FIG. 5C, a router design 502 (which may be instantiated multiple times as routers R3 and R4) may be generated where each unique split VC identifier may be assigned a corresponding discrete value (such as in accordance with step 408). For example, the split VC identifier (0, 0) is mapped to discrete value 0, the split VC identifier (0, 1) is mapped to discrete value 1, and the split VC identifier (1, 0) is mapped to discrete value 2. Further, the discrete value/flat VC identifier 0 and 1 may be mapped to host VC 0, and the discrete values/flat VC identifiers 1 and 2 may be mapped to host VC 1.

Mapping using the split VC identifiers supports the generation of transformation functions enabling one router design to be created for the NoC 302 and allow its instances to remap and direct packets to appropriate host VCs from different NoC VCs. During construction, the VC mapping may be implemented using the transformation functions between the input ports 504 and the output ports 506. The transformation functions may be implemented by determining arrangements of wires between the input ports 504 and the output ports 506. When the NoC is generated the discrete values/flat VC identifiers corresponding to the split VC identifier may be used at the input ports 504 of the multiply instantiated routers of the NoC for directing the packets out from the output ports of the router through appropriate (host) VCs. The multiply instantiated routers may handle the routing of the data packets within the NoC and are replicated to accommodate the complex communication requirements of System on Chips or other integrated circuits.

By generating the router designs 502 based on the allocated VC identifiers, the NoC may efficiently route the data packets to the same hosts 304 using the different NoC VCs. For example, host 304A may require communication with host 304C through host VC 0, and host 304B may also require communication with host 304C through host VC 0. The packets from host 304A may be transmitted through NoC VC 0 and the packets from host 304B may be transmitted through NoC VC 1. When the router R3 associated with the host 304C receives the packets from the hosts 304A and 304B through different NoC VCs, the router R3 may use its transformation function to eject the packet to the host 304C through host VC 0. Using different NoC VCs for each transmitting host 304A and 304B may minimize chances of congestion.

In such embodiments, the method 400 may be suitably adapted to generate router designs 502 (or generally the NoC components) for flows where the NoC VC used within the transport network may be changed. If a flow requires at least some NoC components to receive and transmit packets through different NoC VCs. In such embodiments, transformation functions of routers or NoC components may be configured with the capability to transmit the packets through compatible VCs between neighboring routers.

FIG. 6 illustrates an example computer system 600 on which example embodiments may be implemented. The computer system 600 includes a server 605 which may include an I/O unit 635, storage 660, and a processor 610 operable to execute one or more units as known to one of skill in the art. The term “computer-readable medium” as used herein refers to any medium that participates in providing instructions to processor 610 for execution, which may come in the form of computer-readable storage mediums, such as, but not limited to optical disks, magnetic disks, read-only memories, random access memories, solid state devices and drives, or any other types of tangible media suitable for storing electronic information, or computer-readable signal mediums, which can include transitory media such as carrier waves. The Input / Output (I/O) unit 635 processes input from user interfaces 640 and operator interfaces 645 which may utilize input devices such as a keyboard, mouse, touch device, or verbal command.

The server 605 may also be connected to an external storage 650, which can contain removable storage such as a portable hard drive, optical media (CD or DVD), disk media, or any other medium from which a computer can read executable code. The server may also be connected to an output device 655, such as a display to output data and other information to a user, as well as request additional information from a user. The connections from the server 605 to the user interface 640, the operator interface 645, the external storage 650, and the output device 655 may be via wireless protocols, such as the 802.11 standards, Bluetooth® or cellular protocols, or via physical transmission media, such as cables or fiber optics. The output device 655 may therefore further act as an input device for interacting with a user. The processor 610 may execute one or more modules. The processor 610 may include a control module 611 that may be configured to compute a VC mapping that associates each flow of the NoC with a split VC identifier, the split VC identifier that may include a host VC identifier and a discriminant and generating the NoC includes multiply instantiated routers, where a design of each of the multiply instantiated routers may be configured with allocated VC identifiers according to the VC mapping;

Furthermore, some portions of the detailed description are presented in terms of algorithms and symbolic representations of operations within a computer. These algorithmic descriptions and symbolic representations are the means used by those skilled in the data processing arts to most effectively convey the essence of their innovations to others skilled in the art. An algorithm is a series of defined steps leading to a desired end state or result. In the example embodiments, the steps carried out require physical manipulations of tangible quantities for achieving a tangible result.

Moreover, other implementations of the example embodiments will be apparent to those skilled in the art from consideration of the specification and practice of the example embodiments disclosed herein. Various aspects and/or components of the described example embodiments may be used singly or in any combination. It is intended that the specification and examples be considered as examples, with a true scope and spirit of the embodiments being indicated by the following claims.

WHAT IS CLAIMED IS:

1. A method for generating a Network on Chip (NoC), comprising:
computing a virtual channel mapping that associates each flow of the NoC with a split virtual channel identifier, the split virtual channel identifier comprising a host virtual channel identifier and a discriminant; and
generating the NoC comprising multiply instantiated routers, wherein a design of each of the multiply instantiated routers is configured with allocated virtual channel identifiers according to the virtual channel mapping.

2. The method of claim 1, further comprising remapping the virtual channel identifiers
for each of the multiply instantiated routers based on its connection to other ones of the
multiply instantiated routers.

3. The method of claim 1, wherein allocation of virtual channel identifiers is conducted according to each slice of the design of the multiply instantiated routers.

4. A non-transitory computer-readable medium, storing instructions generating a Network on Chip (NoC), the instructions comprising:
computing a virtual channel mapping that associates each flow of the NoC with a split virtual channel identifier, the split virtual channel identifier comprising a host virtual channel identifier and a discriminant; and
generating the NoC comprising multiply instantiated routers, wherein a design of each of the multiply instantiated routers is configured with allocated virtual channel identifiers according to the virtual channel mapping.

5. The non-transitory computer-readable medium of claim 4, the instructions further comprising remapping the virtual channel identifiers for each of the multiply instantiated routers based on its connection to other ones of the multiply instantiated routers.

6. The non-transitory computer-readable medium of claim 4, wherein allocation of virtual channel identifiers is conducted according to each slice of the design of the multiply instantiated routers.

7. A system comprising, a control module configured to:
compute a virtual channel mapping that associates each flow of a Network on Chip (NoC) with a split virtual channel identifier, the split virtual channel identifier comprising a host virtual channel identifier and a discriminant; and
generate the NoC comprising multiply instantiated routers, wherein a design of each of the multiply instantiated routers is configured with allocated virtual channel identifiers according to the virtual channel mapping.

8. The system of claim 7, the control module is further configured to remap the virtual channel identifiers for each of the multiply instantiated routers based on its connection to other ones of the multiply instantiated routers.

9. The system of claim 7, wherein allocation of virtual channel identifiers is conducted according to each slice of the design of the multiply instantiated routers.
